(19) United States
(12) Patent Application Publication
(10) Pub. No.: US 2003/0028506 A1
(43) Pub. Date: Feb. 6, 2003

(54) Deferred index building systems, methods and computer program products for storing temporally spaced apart bursts of data records in a database

(76) Inventor: Lin Yu, Fort Lauderdale, FL (US)

Correspondence Address: MYERS BIGEL SIBLEY & SAJOVEC, PO BOX 37428, RALEIGH, NC, 27627, US

(21) Appl. No.: 09/896,179

(22) Filed: Jun. 29, 2001

(51) Int. Cl. G06F 7/00

(52) U.S. Cl. 707/1

(57) ABSTRACT

Systems, methods and/or computer program products store temporally spaced apart bursts of data records in a database, by deferring building an index for data records in a respective burst, until after storing at least some of the data records in the respective burst in the database. Index building for all of the data records in a burst may be deferred until after storing all the data records in the burst in the database. Thus, while the data burst is being received, little or no resources may need to be devoted to index building. Rather, index building may begin after termination of a data burst, when more resources may be available.

### FIELD OF THE INVENTION

This invention relates to data processing systems, methods and computer program products, and more particularly to database systems, methods and computer program products.

### BACKGROUND OF THE INVENTION

Database systems, methods and computer program products are widely used for information management. More specifically, database systems, methods and computer program products may be used to reliably manage a large amount of data in a single-user or a multi-user environment. Database systems, methods and computer program products generally include a database that actually stores the data, a database management system and one or more applications that interface with the database management system to provide, for example, user interfaces and other applications.

As is well known to those having skill in the art, relational databases may be provided that are based on a table-column concept, set theoretic relations and/or relational algebra. One widely-available relational database is the Oracle8i relational database system that is marketed by Oracle Corporation. Other database systems may not be based on the above-mentioned attributes, so that they are not relational databases. For example, Indexed Sequential Access Method (C-ISAM) is a database that is marketed by Informix Software, Inc., that is not a relational database. See, for example, the Informix C-ISAM DataBlade Module User's Guide, Version 1.0, December 1999, Part No. 000-6498. Both relational and non-relational databases may be used to manage a large amount of data.

As is well known to those having skill in the art, databases generally facilitate database queries by building an index file in addition to storing the data in a data file. For very large databases, it may be desirable to manage creation of the index file and the data file, to handle large volumes of data.

One application of very large database systems is to store and manage temporal data, i.e., data that is collected over time. Temporal data also may be referred to as “historical” data that describes the business transactions of an enterprise over intervals of time. For example, in Internet-related applications, a mechanism, referred to as “flow”, may be used to establish connection-oriented end-to-end Internet service that behaves as if the two ends are physically connected. More specifically, in Asynchronous Transfer Mode (ATM) technology, flow can be in the form of a Virtual Circuit (VC). Flow also can be in the form of Private Virtual Path (PVP). Flow data may be used to monitor quality of service (QoS) on network service providers, backbone or otherwise. Flow data may be collected over a series of time intervals, the duration of which may be set based upon service provider and/or customer desires.

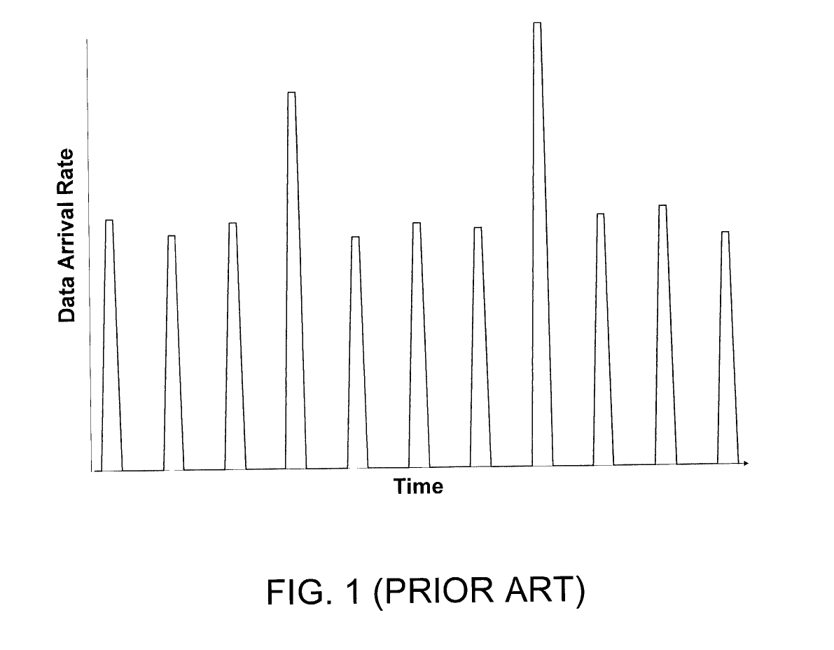

Since quality of service performance data and/or other temporal data may be collected over a series of time intervals, the data may be received as temporally spaced apart bursts of data records. For example, FIG. 1 graphically illustrates data arrival rate versus time for data records, such as flow data. As shown in FIG. 1, large amounts of data are received during a burst of time and no or relatively small amounts of data are received between the bursts of time. The bursts are shown in FIG. 1 to be equally spaced apart. However, in other scenarios, the bursts need not be equally spaced apart, and also need not be of equal burst length. As also shown in FIG. 1, the same amount of data need not be received during each burst.

Unfortunately, it may be difficult for databases to efficiently store temporally spaced apart bursts of data records. Moreover, these difficulties may be exacerbated when the number of bursts, the number of data records per burst and/or the number of sources of the bursts of data records becomes large.

### SUMMARY OF THE INVENTION

Embodiments of the present invention provide systems, methods and/or computer program products for storing temporally spaced apart bursts of data records in a database, by deferring building an index for a plurality of data records in a respective burst, until after storing the plurality of data records in the respective burst in the database. In other embodiments, index building for all of the data records in a respective burst are deferred until after storing all the data records in the respective burst in the database. Thus, while the data burst is being received, little or no resources may need to be devoted to index building. Rather, index building may begin after termination of a data burst, when more resources may be available.

In other embodiments of the invention, temporally spaced apart bursts of data records are received during a corresponding series of spaced apart time intervals. Deferred building of an index takes place by storing the spaced apart bursts of data records in the database during the corresponding series of spaced apart time intervals, and beginning to build the index for a corresponding one of the spaced apart bursts after expiration of the corresponding one of the series of spaced apart time intervals.

In yet other embodiments, the entire index for the corresponding one of the spaced apart bursts is built after expiration of the corresponding one of the series of spaced apart time intervals. In still other embodiments, the index for the corresponding one of the spaced apart bursts is built after expiration of the corresponding one of the series of spaced apart time intervals and is completed prior to beginning the next one of the series of spaced apart time intervals.

In some of the above embodiments, the storing may be performed by a first processor, and the index building may be performed by a second processor. In other embodiments, the storing and building may be performed alternatingly by a single processor.

It will be understood that embodiments of the present invention may be embodied as methods, systems and/or computer program products that may be applications or modules that execute on and interface with a database management system. Alternatively, systems, methods and/or computer program products according to embodiments of the present invention may be embodied in one or more modules that is integrated into a database management system. Systems, methods and/or computer program products according to embodiments of the present invention may execute in a mainframe environment, in a client/server environment and/or in a distributed database environment. Finally, although systems, methods and/or computer program products according to embodiments of the invention are described herein primarily with regard to C-ISAM databases, they may be used with any other database system that stores temporal data, such as Sybase, marketed by Sybase, Inc.; Oracle, marketed by Oracle Corporation; Ingres marketed by Computer Associates International, Inc. and DB2, marketed by IBM Corporation. Improved systems, methods and/or computer program products for storing temporally spaced apart bursts of data records in a database thereby may be provided.

### BRIEF DESCRIPTION OF THE PREFERRED EMBODIMENTS

FIG. 1 graphically illustrates data arrival rate versus time for bursts of data records, such as flow data.

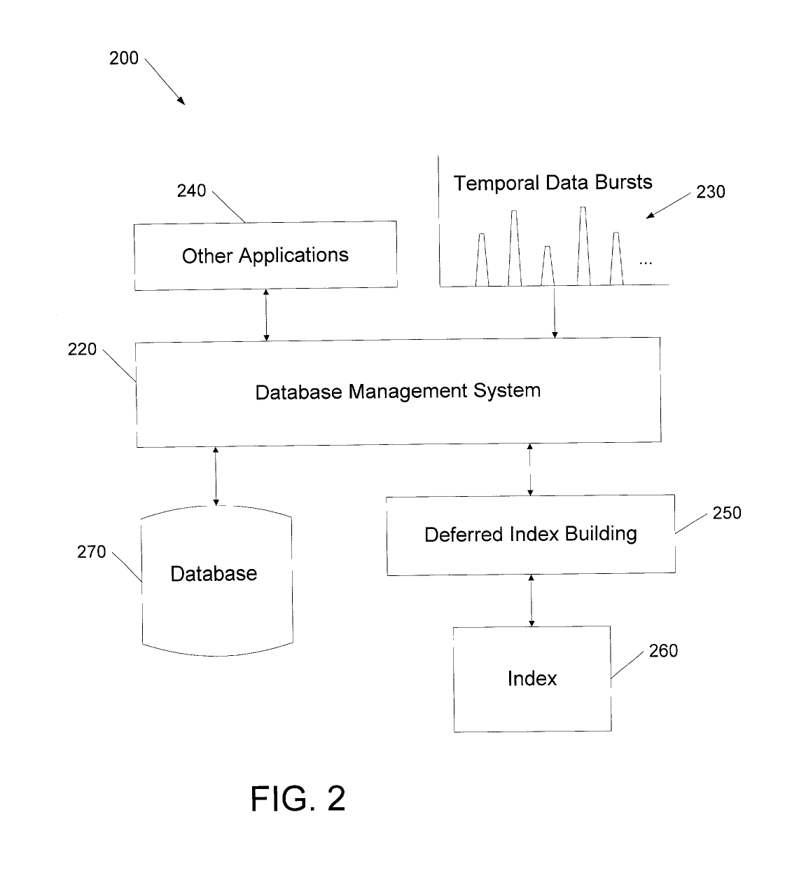

FIG. 2 is a block diagram of database systems, methods and/or computer program products according to embodiments of the present invention.

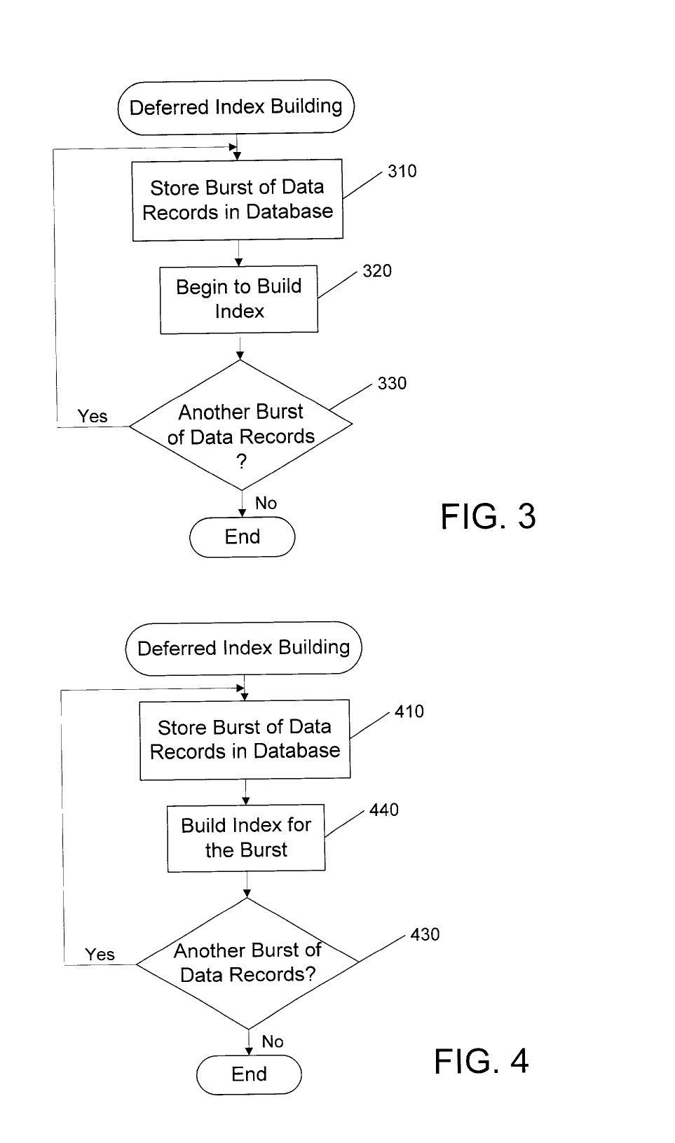

FIGS. 3 and 4 are flowcharts of operations that may be performed by embodiments of deferred index building systems, methods and/or computer program products according to embodiments of the present invention.

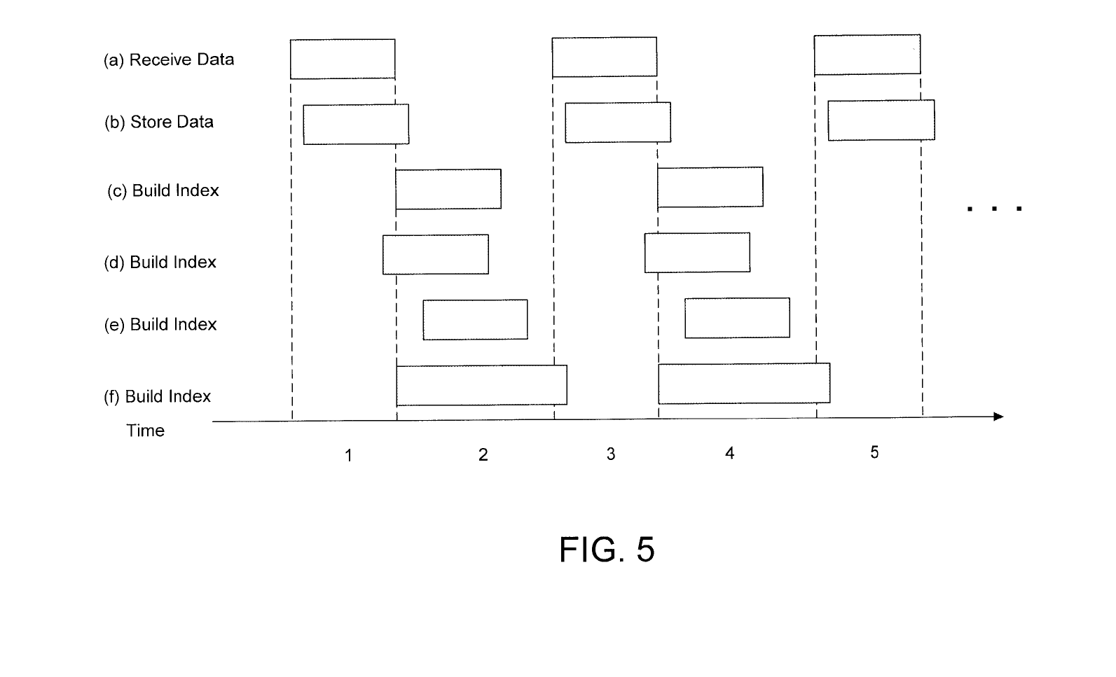

FIG. 5 is a timing diagram that graphically illustrates deferred index building according to embodiments of the present invention.

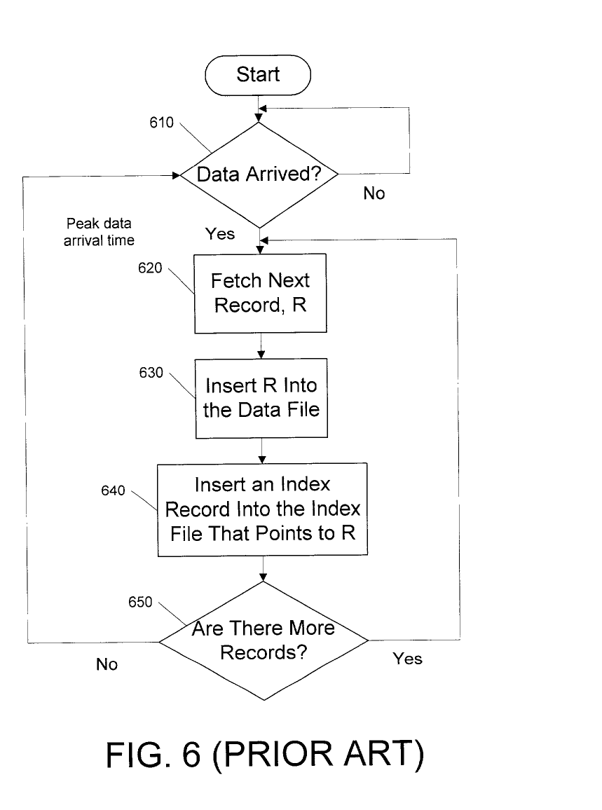

FIG. 6 is a flowchart that illustrates conventional building of an index file on a per-record basis.

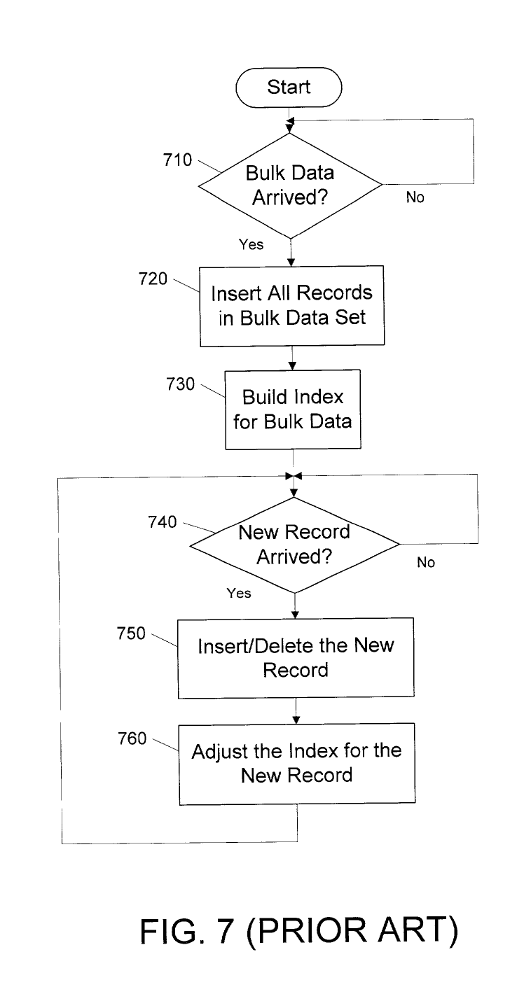

FIG. 7 is a flowchart that illustrates conventional building of an initial database index after initially loading bulk data.

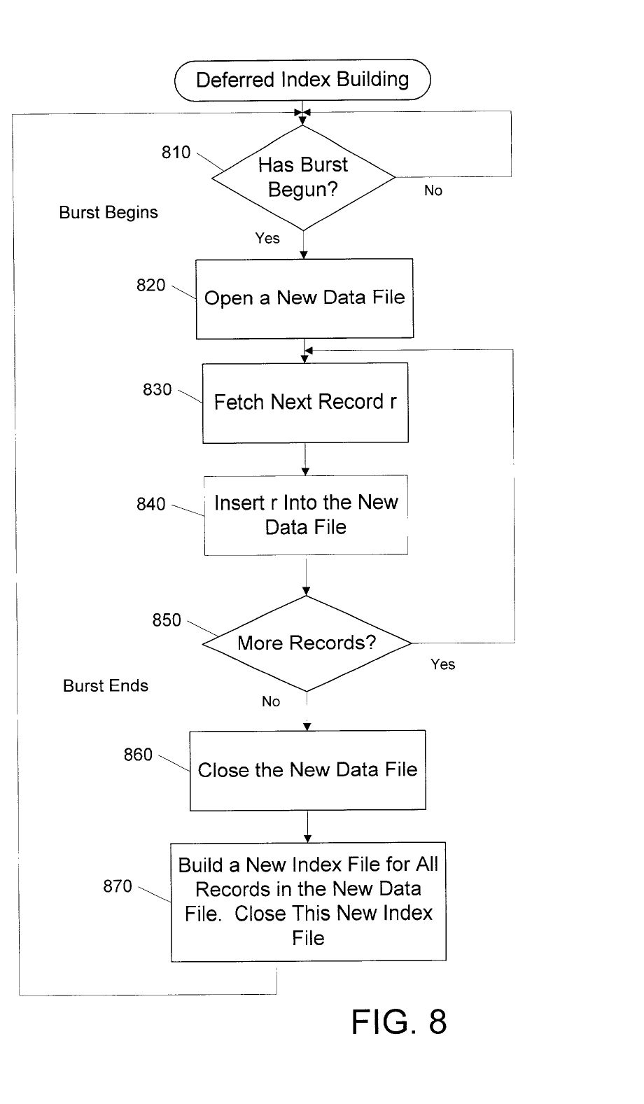

FIG. 8 is a flowchart of operations that may be performed by systems, methods and/or computer program products for deferred index building according to other embodiments of the present invention.

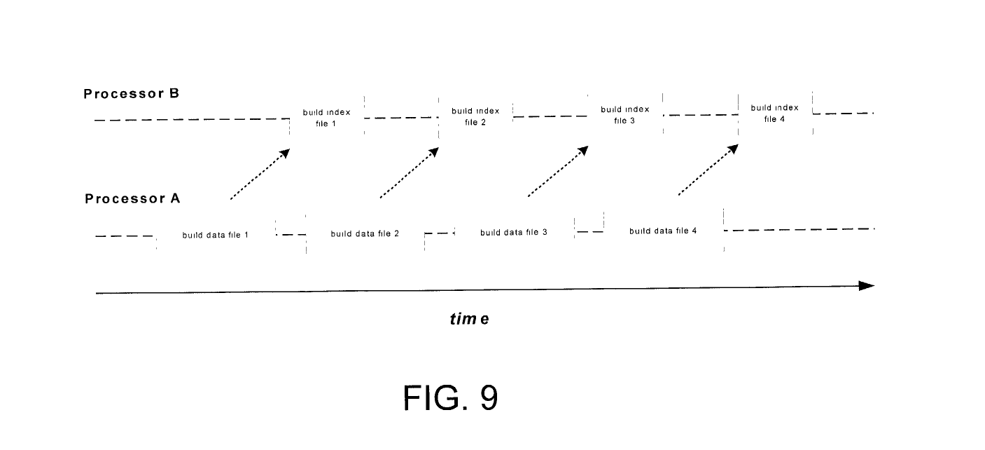

FIG. 9 is a block diagram illustrating parallel building a data file and building an index file according to embodiments of the present invention.

### DETAILED DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As also will be appreciated by one of skill in the art, the present invention may be embodied as methods, data processing systems, and/or computer program products. Accordingly, the present invention may take the form of an entirely hardware embodiment, an entirely software embodiment running on general purpose hardware or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet and/or magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, or in various other programming languages. Software embodiments of the present invention do not depend on implementation with a particular programming language. Portions of the program code may execute entirely on one or more data processing systems.

Referring now to FIG. 2, a block diagram of database systems, methods and/or computer program products according to embodiments of the present invention now will be described. As shown in FIG. 2, database systems, methods and/or computer program products 200 according to embodiments of the present invention include a database 270 that stores temporally spaced apart bursts of data records 230, also referred to as temporal data bursts, and a database management system 220. Deferred index building systems, methods and/or computer program products 250 also are included, that defer building an index 260 for a plurality of data records in a respective burst, until after storing the plurality of data records in the respective burst in a database 270. In other embodiments of the invention, deferred index building systems, methods and/or computer program products 250 defer building an index 260 for all the data records in a respective burst 230, until after storing all of the data records for the respective burst in the database 270. One or more other applications 240 may interface with the database management system 220, for example to support user queries.

It will be understood that the database management system 220, the database 270, the index 260 and/or the other applications 240 may be embodied, in whole or in part, in a C-ISAM database management system and/or other database management system. Moreover, although deferred index building systems, methods and/or computer program products 250 according to embodiments of the invention are shown in FIG. 2 as being separate from the database management system 220, they also may be embodied as one or more modules that are incorporated into the database management system 220. Combinations of internal and external modules for deferred index building 250 also may be provided. It also will be understood that, although the database 270 and the index 260 are illustrated as being separate entities, they may be integrated within a single entity. Finally, the elements of FIG. 2 may be embodied in a lumped system, a distributed system and/or a client server system, and may be directly connected to one another and/or may be connected via a network including public and/or private, local and/or wide area networks such as the Internet.

FIG. 3 is a flowchart of operations that may be performed by deferred index building systems, methods and/or computer program products according to embodiments of the present invention, such as deferred index building systems, methods and/or computer program products 250 of FIG. 2. Referring now to FIG. 3, the temporally spaced apart bursts of data records are received during a corresponding series of spaced apart time intervals. As shown at Block 310, a burst of data records is stored in the database during the corresponding time interval. Then, at Block 320, the index for the burst is begun to be built after expiration of the corresponding spaced apart time interval. Then, at Block 330, if there are additional bursts of data records, the storing of Block 310 and the beginning to build an index of Block 320 again are performed.

FIG. 4 is a flowchart of operations that may be performed by other deferred index building systems, methods and/or computer program products according to embodiments of the invention that may correspond to deferred index building systems, methods and/or computer program products 250 of FIG. 2. As shown in FIG. 4 at Block 410, the bursts of data records are stored in a database similar to Block 310 of FIG. 3. Then, at Block 440, the entire index for the corresponding burst is built after expiration of the burst, and also may be completed prior to the beginning of the next burst. Thus, in contrast with Block 320, where only some of the index may be built after expiration of the corresponding one of the series of spaced apart time intervals, at Block 440, the entire index is built between the spaced apart time intervals. Finally, at Block 430, if there are additional bursts of data records, the storing of Block 410 and the building of an index of Block 440 again are performed.

FIG. 5 is a timing diagram which graphically illustrates deferred index building according to embodiments of the present invention. As shown in FIG. 5 at lines (a) and (b), bursts of data records are received by the database management system, such as the database management system 220 of FIG. 2, and stored in the database, such as the database 270 of FIG. 2, over a plurality of temporally spaced apart time intervals 1, 3, 5 . . . . In FIG. 5, the series of spaced apart time intervals 1, 3, 5 . . . are of equal size and are equally spaced apart. However, the time intervals need not be equal size, and need not be equally spaced apart. Also, the times, 2, 4 . . . between the spaced apart time intervals 1, 3, 5 . . . may be equal and/or unequal and the same and/or different duration than the spaced apart time intervals 1, 3, 5 . . . . Moreover, rows (a) and (b) of FIG. 5 illustrate a slight lag between the receipt of data (line (a)) and the storage of data (line (b)) during a given time interval 1, 3, 5 . . . , because there generally is a finite delay from the time the data is received at the database management system to the time the data is stored in the database. However, this delay generally is short, so that, to a first approximation, it may be regarded that the data is received and stored during the time interval 1, 3, 5 . . . .

Referring now to row (c) of FIG. 5, in these embodiments, the entire index is built between the spaced apart time intervals 1, 3 and 5 . . . . Specifically, the entire index is built during time intervals 2, 4 . . . . Stated differently, the index is begun to be built after expiration of the spaced apart time intervals 1, 3, 5 . . . during which a data burst is received, and building of the index is completed prior to beginning a next one of the series of spaced apart time intervals 1, 3, 5 . . . during which a data burst is received.

In contrast, in embodiments shown at row (d) of FIG. 5, beginning index building may take place prior to receiving all of the data records in a burst. For example, if the rate of data receipt in a burst tapers off towards the end of the burst, as illustrated conceptually in FIG. 1, index building may begin when the data rate begins to taper off. Thus, in embodiments of the invention that are illustrated in FIG. 5, line (d), building of an index for a plurality, but not all, of the data records in a respective burst is deferred until after storing the plurality of data records in the respective burst in the database. In contrast, embodiments of FIG. 5, line (c), building an index for all the data records in a respective burst is deferred until after storing all the data records in the respective burst in the database.

Line (e) of FIG. 5 illustrates that the entire index may be built between data bursts, according to other embodiments of the invention, with a dwell time or gap being allowed to transition between storing data and building an index. Embodiments of line (e) of FIG. 5 may be particularly suited when a single data processor is used to store the data in the database and to build the index. Accordingly, embodiments of FIG. 5, line (e) can ensure that there is no overlap between storing the data and building the index. Thus, throughput can be increased or maximized and processor loading can be increased or maximized.

Finally, FIG. 5, line (f) illustrates that, in other embodiments of the invention, the index building need not be completed until after beginning of a next or immediately succeeding burst of data records. For example, if the rate of data receipt in a burst ramps up at the beginning of the bursts, as illustrated conceptually in FIG. 1, index building may be completed as the data rate ramps up.

Embodiments of FIG. 5, lines (d) and (f) may be particularly suited to multiprocessor environments, wherein a first processor performs the data storing and a second processor performs the index building, so that overlap may be allowed. However, it also will be understood that all the embodiments of FIG. 5 may be embodied in a single processor system and/or a multi-processor system.

A detailed description of additional database systems, methods and/or computer program products according to embodiments of the invention now will be described. Moreover, these embodiments will be contrasted with conventional techniques that can defer building of an index upon initial database loading. For ease of explanation, C-ISAM databases and flow data that were described above will be used. However, it will be understood that deferred indexing may be used with other databases and/or other temporal data.

C-ISAM may be used as a database management system such as a database management system 220 of FIG. 2 due to its potentially high throughput. In C-ISAM, data records and the index of the records reside in two separate files, shown for example in FIG. 2 as a database 270 and an index file 260, respectively. Indexes may be built on any attributes of the records. C-ISAM can allow queries to find a record that matches a key attribute value if there is an index built over these attributes. A sequential search then may be performed. Queries on non-indexed attribute values may not be possible in C-ISAM. Also, to keep the files of manageable size so as to speed up index building and query processing, the data and index files may be closed periodically and new data and index files may be created for newly arrived data.

The advancement of network technologies may enable network service providers to provide increasing bandwidth to handle increasing network traffic. A network service management system should be able to scale well to allow rapid network advancement. Preferably, it should operate in real time. Hence, it should be able to handle large amounts of QoS performance data that is collected from the network at a given time. Since network QoS performance data generally is collected at spaced apart time intervals, input QoS performance data generally is received in spaced apart bursts of data records as was illustrated in FIG. 1. Therefore, it may be desirable to handle, in real time, large quantities of data that are received at spaced apart peak data arrival times.

In order to be able to handle large bursts of data, the underlying database should be able to store the data efficiently. Since the data may be historical records, the records may not need to be modified after they are stored in the database. Thus, it may be desirable to efficiently insert or store records into the database. Moreover, in an effort to insert records into the database quickly, the ability to efficiently query the data should not be unduly compromised. In order to efficiently process queries, indices generally should be built over data records.

Performance experiments showed that the speed of C-ISAM to insert flow data into a database can be about 500-800% faster than an Oracle relational database, depending on whether transaction control is used. In order to allow high performance and/or to scale well, the speed in which a burst of flow data is inserted into a database during peak data arrival time should exceed the observed speed of an Oracle relational database. Thus, C-ISAM may be used to store flow data, according to some embodiments of the invention. Since non-performance data does not impose as high a performance demand on the repository as that of flow data, Oracle may continue to be used to store the non-flow data, according to some embodiments of the invention. By using C-ISAM to store flow data, as opposed to using Oracle to accomplish the same, processing speed can be increased, at the potential tradeoff of a reduced ability to query performance data using SQL. Finally, as was described above, other conventional database systems may be used to store the flow data and/or to store the non-flow data.

Conventionally, a C-ISAM data file and an index file may be built simultaneously. Stated differently, for each record inserted into a data file, an index record may be created in the index file that points to the newly inserted record in the data file. Thus, as shown in FIG. 6, conventionally, a test is made at Block 610 as to whether data has arrived. Once data has arrived, a next record R is fetched at Block 620. That record R is inserted into the database at Block 630. An index record then is built that points to the record R, and is inserted into the index file at Block 640. If there are more records at Block 650, the operations of Blocks 620-640 are repeated until there are no more records at Block 650. Operations then wait at Block 610 until more data arrives. Thus, conventionally, when building a C-ISAM data file, an index file may be built for each record that is inserted into the data file, simultaneously with the inserting of the record into the file.

Another conventional technique of building an initial database index is illustrated in FIG. 7. Before initially loading bulk data (Block 710), index building may be turned off. After the initial bulk data loading (Block 720), index building is turned on, and an index is built for the data that was loaded (Block 730). Thereafter, for each record that is inserted or deleted (Block 740), the new record is inserted or deleted (Block 750) and the index file is adjusted incrementally (Block 760). Thus, an initial index is built after initial database loading, and the index is then updated on a per record basis.

Embodiments of the invention may stem from realizations that when inserting flow records without specifying a key structure, thus building a C-ISAM data file without actually building an index file, the insertion speed can be improved, for example by about 50% on Sun Ultra 10 and Sun 450 servers. Thus, it was realized that it is possible to build a C-ISAM data file during peak data arrival time without building the index file. It also was realized that after completion of building the data file, during an off-peak time, a possibly slower technique may be used to build an index file over all of the newly inserted records in that new data file.

Accordingly, embodiments of the invention can defer building an index for a plurality of records in a respective burst until after storing the plurality of data records in the respective burst in the database. An analogous scenario may be seen in the evolution of cows. To ensure a cow eats the most available food, a cow first swallows food at fast pace without chewing, and stores the food inside its stomach. Later on, the cow ruminates cud at a slower pace.

FIG. 8 is a flowchart illustrating other systems, methods and/or computer program products for deferred index building according to other embodiments of the present invention, that may correspond to deferred index building 250 of FIG. 2. Referring now to FIG. 8, at Block 810, a determination is made as to whether a burst has begun. This may be determined based on expiration of a predetermined time, a sensed ramp-up of the rate of data receipt and/or other conventional techniques well known to those having skill in the art. At Block 820, when a burst begins, a new data file is opened. At Block 830, a next record r in the new data file is fetched, and at Block 840, the new record r is inserted into the new data file. If more records are present in the burst of data records at Block 850, then the operations of Blocks 830 and 840 are repeatedly performed until no more records are available at Block 850, thus signifying that the burst has ended.

Still referring to FIG. 8, when the burst has ended at Block 860, the new data file is closed. At Block 870, a new index file is built for all the records in the new data file. The new index file then is closed, and operations wait until the next burst arrives at Block 810. Note that each time operations return to Block 820, a new data file is created, and each time the flow reaches Block 860, the newly created data file is closed, and a new index file is subsequently built for that closed data file. In contrast to FIG. 7, incremental index adjustment need not be performed after an index file is built for a given data file, since newly arrived records need not be inserted into data files for which index files have already been built.

It will be understood that C-ISAM and many other database systems may not include a deferred indexing option. However, deferred indexing may be implemented in C-ISAM and in other databases, by performing the following low level operations. Prior to building an index, C-ISAM includes a structure that specifies key column information to be set up. In this structure, the offset of the key column, the length of the key column and the data type of the key column may be specified. The offset of the key column defines at which byte the key column begins. For example, 0 specifies that the key column is offset 0 bytes from the beginning of the record, 4 specifies that the key column starts at the fourth byte, etc. The length of the key column indicates how many bytes long the key column is, and the data type of the key column indicates whether the key column is an integer, character, etc. There are a maximum of eight key columns that can be specified in a C-ISAM index key structure. Thus, at most, eight columns can be used as a key in C-ISAM. These key columns can be turned on and off in the structure before building index files.

In order to implement deferred indexing in C-ISAM according to embodiments of the present invention, after opening a new data file at Block 820, but prior to completing inserting the records into a data file, all of the key columns in the key structure may be turned off. Thus, even though conventional C-ISAM index building may be activated as records are fetched and inserted into the data file (Blocks 830 and 840), since no columns are used in this round of index building, there is no index built for all practical purposes. After the data file is closed at Block 860, the columns in the key structure may be turned on again, before building an index file for all records in the data file in Block 870. Thus, although C-ISAM does not have a deferred index building option, deferred indexing according to embodiments of the invention may be implemented in C-ISAM. Other low-level operational techniques may be used to implement deferred index building in C-ISAM and/or in other databases, according to embodiments of the present invention.

Embodiments of the invention can allow high throughput during the peak data arrival time (burst), so that during this time, in the queue for the input flow data, the storage rate may be no less than the receiving rate at any given moment. Thus, the database can process and accept incoming QoS data in real time. Stated differently, the probability of the database being choked, the received data records not being processed on time and subsequently dropped and/or a client process having very slow server response time can be low.

C-ISAM performance experiments were carried out on Sun Ultra 10 and Sun 450 servers, where the disks are not RAIDed. The experiments inserted 10 or 25 million records into and read 10 or 25 million records from a C-ISAM data file. The read and write throughput was measured in records per second. Experiments were run with deferred index building according to embodiments of the invention. As a control group, experiments also were run that build an index file while building the data file, as was illustrated in FIG. 6. As shown in Table 1, the peak data arrival time data file write performance gain using a deferred index building technique according to embodiments of the invention was about 50 percent, compared to building the data file and the index file simultaneously. Table 1 shows the performance statistics of the experiments.

TABLE 1

| | Sun Ultra 10 | | Sun 450 | |
|---|---|---|---|---|
| | Normal | Deferred | Normal | Deferred |
| | Index | Index | Index | Index |
| | Building | Building | Building | Building |
| 10 Million Records | | | | |
| Write | 10,964 | 16,233 | 10,729 | 16,103 |
| Read | 12,048 | 12,210 | 12,195 | 12,531 |
| Index Building Time | N/A | 464 sec | N/A | 461 sec |
| | | 21,551/sec | | 21,691/sec |
| Write Improvement With | 48% | | 50% | |
| Deferred Index Building | | | | |
| 25 Million Records | | | | |
| Write | N/A | N/A | 10,283 | 16,313 |
| Read | N/A | N/A | 12,160 | 12,183 |
| Index Building Time | N/A | N/A | N/A | 897 sec |
| | | | | 27,870/sec |

| | | |
|---|---|---|
| Write Improvement with | N/A | 58% |
| Deferred Index Building | | |

The performance tests were carried out in a controlled environment in which few other processes were executing. In a more realistic environment, the performance improvement may be less than that shown in Table 1. However, in a system whose disks are striped and/or are controlled by RAID controllers, the overall performance improvement may improve substantially from that shown in Table 1.

From the experimental results shown in Table 1, C-ISAM may provide a better tool to handle bursts of data records than Oracle. Theoretically, the performance of an Oracle database can be improved for flow data at the rate of 1,894 records per second by up to five-fold (500%) on Sun Ultra 10 and Sun 450 servers. Coupled with deferred index building according to embodiments of the invention, an additional 48% throughput improvement may be obtained, with a potential total throughput improvement of up to eight-fold over an Oracle-based system.

It will be understood that the above-described experiments were carried out in an environment where there was no other resource-competing server component running on the same CPU as C-ISAM. Moreover, flow data was generated internally, and there was no input flow data processing before being inserted into the C-ISAM data file. As such, the performance results listed in Table 1 may be theoretical limits. In a real operational environment, the overhead may be higher, and the actual throughput may be lower.

It also will be understood that in using deferred index building according to embodiments of the invention, the ability to query new data with good response time may not be delayed beyond a reasonable amount of time. That is, the time between the completion of building a data file and the completion of building the index file may be within a reasonable time limit. This time limit may be controlled by a system parameter that may be a multiple of the lowest common denominator of time intervals. Recall that in some embodiments, as this time limit expires, the current data file may be closed, an index file may be built, and a new data file may be opened and written into for QoS data arriving at the next time interval. However, these time limit constraints may be reduced or eliminated in a multi-processor system, as will now be described.

In particular, in C-ISAM, simple range queries can be performed very quickly if index files are built with collection time (a timestamp) as the primary key column and flow ID as the secondary key column. Experiments have shown that the time to find all records of a given flow from a C-ISAM data file containing 10 million performance records for 100,000 distinct flows can be about 1 second. However, data that has been inserted into data file but whose index file has yet been built may not be queried efficiently.

Building index files may take a substantial amount of time. In C-ISAM performance experiments with deferred index building according to embodiments of the invention, during the peak performance data arrival time, up to 16,000 records per second can be processed. The time to build an index file for a data file of 10,000,000 performance data records (equivalent to one day's data for systems handling 100,000 network connections), after the creation of that data file, is about 460 seconds (about 7.5 minutes ), or about 21,740 index records per second. These are experimental limits. The approximate processing time (in seconds) in terms of the number of performance data records based on the experimental limits is shown in Table 2.

TABLE 2

| Number of Network Connection Records | 10,000 | 25,000 | 50,000 | 75,000 | 100,000 | 250,000 | 500,000 | 750,000 | 1,000,000 |
|---|---|---|---|---|---|---|---|---|---|
| Time to Build Data File, Seconds | 0.7 | 1.6 | 3.2 | 4.7 | 6.3 | 15.7 | 31.3 | 46.9 | 62.5 |
| Time to Build Index File, Seconds | 0.5 | 1.2 | 2.5 | 3.5 | 4.8 | 12 | 24 | 35.7 | 47.6 |

For data availability purposes, the time gap between the time of completion of building a data file and the time the data is available for efficient querying should be small. Assume that the time gap is x seconds (x=5, 10, 15, 20, . . . , 60, . . . seconds). Also assume that the time to build that index file is y. Thus, a constraint may be that x=y. Then, the time gap between the completion of building a data file and the start of building its index file is z=x−y. Thus, x=y+z.

To satisfy a desired data availability, it may be desirable to maintain x small. In particular, y may be fixed by the database capabilities. That means z should be kept small. Moreover, to maintain the throughput performance level close to the upper limits of the database, the database should not need to wait for the index file build completion before beginning to process more incoming performance data. Thus, it may be desirable to be able to build a new data file and an old index file in parallel.

Embodiments of the invention may run on Sun 450 servers that have four processors. To take advantage of the multiprocessor architecture of Sun 450 machines and/or other multiple processor systems, separate processors may be used for building data files and for building index files. Thus, as shown in FIG. 9, after creating a data file on processor A, the index building for that data file is started on processor B, and the next data file is built on processor A. Since for a given number of flow records, index file building may take time less than that for data file building, this parallel processing can be performed smoothly, as shown in FIG. 9. By performing parallel processing in a multi-processor system, x can be reduced or minimized while the system's availability to process incoming data for the next time interval can be improved or maximized.

Thus, separate processors may be allocated for building the data file and building the index file. On a Sun 450, issuing a command to run both a job building a data file and a job building an index file simultaneously can accomplish this. The operating system will choose available processors to run the two jobs in parallel. Other techniques may be used in other multi-processor systems

Accordingly, deferred index building according to embodiments of the invention can improve throughput. Furthermore, with deferred index building, building indices can be performed on another processor in a multi-processor system, separate from building the data file itself. On multi-processor systems, with parallel processing of data and index files, the process can be made very robust.

Deferred index building systems, methods and computer program products according to embodiments of the invention can be applied to database systems that can support, or can be made to support, a deferred index building option. Partitioned tables may be used where, for example, each of the sub-partitions maintains historical data that is not subject to future modification, has its own local indices, and deferred index building according to embodiments of the invention can be applied to the sub-partitions and local indices. Thus, deferred index building according to embodiments of the invention may have very wide applicability.

The flowcharts and block diagrams of FIGS. 2-5 and 8-9 illustrate the architecture, functionality, and operation of possible implementations of systems, methods and computer program products according to embodiments of the invention. In this regard, each block in the flowcharts or block diagrams can represent a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method of storing temporally spaced apart bursts of data records in a database, comprising:
deferring building an index for a plurality of data records in a respective burst until after storing the plurality of data records in the respective burst in the database.

2. A method according to claim 1 wherein the deferring comprises:
deferring building an index for all the data records in a respective burst until after storing all the data records in the respective burst in the database.

3. A method according to claim 2 wherein the temporally spaced apart bursts of data records are received during a corresponding series of spaced apart time intervals, the deferring further comprising:
storing the spaced apart bursts of data records in the database during the corresponding series of spaced apart time intervals; and
beginning to build the index for a corresponding one of the spaced apart bursts after expiration of the corresponding one of the series of spaced apart time intervals.

4. A method according to claim 3 wherein the beginning comprises:
building the index for the corresponding one of the spaced apart bursts after expiration of the corresponding one of the series of spaced apart time intervals.

5. A method according to claim 3 wherein the building comprises:
building the index for the corresponding one of the spaced apart bursts after expiration of the corresponding one of the series of spaced apart time intervals and prior to beginning a next one of the series of spaced apart time intervals.

6. A method according to claim 3 wherein the storing is performed by a first processor and the beginning is performed by a second processor.

7. A method according to claim 5 wherein the storing and building are performed alternatingly by a single processor.

8. A method according to claim 1 wherein the database is an Indexed Sequential Access Method (ISAM) database.

9. A method of storing, in a database, temporally spaced apart bursts of data records that are received during a corresponding series of spaced apart time intervals, the method comprising:
storing the spaced apart bursts of data records in the database during the corresponding series of spaced apart time intervals; and
beginning to build the index for a corresponding one of the spaced apart bursts after expiration of the corresponding one of the series of spaced apart time intervals.

10. A method according to claim 9 wherein the beginning comprises:
building the index for the corresponding one of the spaced apart bursts after expiration of the corresponding one of the series of spaced apart time intervals.

11. A method according to claim 9 wherein the building comprises:
building the index for the corresponding one of the spaced apart bursts after expiration of the corresponding one of the series of spaced apart time intervals and prior to beginning a next one of the series of spaced apart time intervals.

12. A method according to claim 9 wherein the storing is performed by a first processor and the beginning is performed by a second processor.

13. A method according to claim 11 wherein the storing and building are performed alternatingly by a single processor.

14. A system for storing temporally spaced apart bursts of data records, comprising:
a database; and
means for deferring building an index for a plurality of data records in a respective burst until after storing the plurality of data records in the respective burst in the database.

15. A system according to claim 14 wherein the means for deferring comprises:
means for deferring building an index for all the data records in a respective burst until after storing all the data records in the respective burst in the database.

16. A system according to claim 15 wherein the temporally spaced apart bursts of data records are received during a corresponding series of spaced apart time intervals, the means for deferring further comprising:
means for storing the spaced apart bursts of data records in the database during the corresponding series of spaced apart time intervals; and
means for beginning to build the index for a corresponding one of the spaced apart bursts after expiration of the corresponding one of the series of spaced apart time intervals.

17. A system according to claim 16 wherein the means for beginning comprises:
means for building the index for the corresponding one of the spaced apart bursts after expiration of the corresponding one of the series of spaced apart time intervals.

18. A system according to claim 16 wherein the means for building comprises:
means for building the index for the corresponding one of the spaced apart bursts after expiration of the corresponding one of the series of spaced apart time intervals and prior to beginning a next one of the series of spaced apart time intervals.

19. A system according to claim 16 wherein the means for storing is embodied in a first processor and the means for beginning is embodied in a second processor.

20. A system according to claim 18 wherein the means for storing and means for building are activated alternatingly in a single processor.

21. A system according to claim 14 wherein the database is an Indexed Sequential Access Method (ISAM) database.

22. A system for storing, in a database, temporally spaced apart bursts of data records that are received during a corresponding series of spaced apart time intervals, the system comprising:
means for storing the spaced apart bursts of data records in the database during the corresponding series of spaced apart time intervals; and
means for beginning to build the index for a corresponding one of the spaced apart bursts after expiration of the corresponding one of the series of spaced apart time intervals.

23. A system according to claim 22 wherein the means for beginning comprises:
means for building the index for the corresponding one of the spaced apart bursts after expiration of the corresponding one of the series of spaced apart time intervals.

24. A system according to claim 22 wherein the means for building comprises:
means for building the index for the corresponding one of the spaced apart bursts after expiration of the corresponding one of the series of spaced apart time intervals and prior to beginning a next one of the series of spaced apart time intervals.

25. A system according to claim 22 wherein the means for storing is embodied in a first processor and the means for beginning is embodied in a second processor.

26. A system according to claim 24 wherein the means for storing and means for building are activated alternatingly in a single processor.

27. A system according to claim 22 in combination with the database.

28. A computer program product for storing temporally spaced apart bursts of data records in a database, the computer program product comprising a computer-readable storage medium having computer-readable program code embodied in the medium, the computer-readable program code comprising:
computer-readable program code that is configured to defer building an index for a plurality of data records in a respective burst until after storing the plurality of data records in the respective burst in the database.

29. A computer program product according to claim 28 wherein the computer-readable program code that is configured to defer comprises:
computer-readable program code that is configured to defer building an index for all the data records in a respective burst until after storing all the data records in the respective burst in the database.

30. A computer program product according to claim 28 wherein the temporally spaced apart bursts of data records are received during a corresponding series of spaced apart time intervals, the computer-readable program code that is configured to defer further comprising:
computer-readable program code that is configured to store the spaced apart bursts of data records in the database during the corresponding series of spaced apart time intervals; and
computer-readable program code that is configured to begin to build the index for a corresponding one of the spaced apart bursts after expiration of the corresponding one of the series of spaced apart time intervals.

31. A computer program product according to claim 30 wherein the computer-readable program code that is configured to begin comprises:
computer-readable program code that is configured to build the index for the corresponding one of the spaced apart bursts after expiration of the corresponding one of the series of spaced apart time intervals.

32. A computer program product according to claim 30 wherein the computer-readable program code that is configured to build comprises:
computer-readable program code that is configured to build the index for the corresponding one of the spaced apart bursts after expiration of the corresponding one of the series of spaced apart time intervals and prior to beginning a next one of the series of spaced apart time intervals.

33. A computer program product according to claim 30 wherein the computer-readable program code that is configured to store is configured to execute on a first processor and the computer-readable program code that is configured to begin is configured to execute on a second processor.

34. A computer program product according to claim 32 wherein the computer-readable program code that is configured to store and the computer-readable program code that is configured to build are configured to execute alternatingly on a single processor.

35. A computer program product according to claim 28 wherein the database is an Indexed Sequential Access Method (ISAM) database.

36. A computer program product according to claim 28 in combination with computer-readable program code that is configured to provide the database.

37. A computer program product for storing, in a database, temporally spaced apart bursts of data records that are received during a corresponding series of spaced apart time intervals, the computer program product comprising a computer-readable storage medium having computer-readable program code embodied in the medium, the computer-readable program code comprising:
computer-readable program code that is configured to store the spaced apart bursts of data records in the database during the corresponding series of spaced apart time intervals; and
computer-readable program code that is configured to begin to build the index for a corresponding one of the spaced apart bursts after expiration of the corresponding one of the series of spaced apart time intervals.

38. A computer program product according to claim 37 wherein the computer-readable program code that is configured to begin comprises:
computer-readable program code that is configured to build the index for the corresponding one of the spaced apart bursts after expiration of the corresponding one of the series of spaced apart time intervals.

39. A computer program product according to claim 37 wherein the computer-readable program code that is configured to build comprises:
computer-readable program code that is configured to build the index for the corresponding one of the spaced apart bursts after expiration of the corresponding one of the series of spaced apart time intervals and prior to beginning a next one of the series of spaced apart time intervals.

40. A computer program product according to claim 37 wherein the computer-readable program code that is configured to store is configured to execute on a first processor and the computer-readable program code that is configured to begin is configured to execute on a second processor.

41. A computer program product according to claim 39 wherein the computer-readable program code that is configured to store and the computer-readable program code that is configured to build are configured to execute alternatingly on a single processor.

42. A computer program product according to claim 37 in combination with computer-readable program code that is configured to provide the database.
